(19) United States
(12) Patent Application Publication
(10) Pub. No.: US 2016/0148330 A1
(43) Pub. Date: May 26, 2016

(54) Providing Mentor Assistance in an Embedded Marketplace

(71) Applicant: Pluralsight, LLC, Farmington, UT (US)

(72) Inventors: Edward Roman, Houston, TX (US); Forest Good, Salt Lake City, UT (US); Geraldo Ramos, Salt Lake City, UT (US); Assis Antunes, Salt Lake City, UT (US)

(21) Appl. No.: 14/952,708

(22) Filed: Nov. 25, 2015

Related U.S. Application Data
(60) Provisional application No. 62/084,238, filed on Nov. 25, 2014.

(51) Int. Cl. G06Q 50/20; G09B 5/06

(52) U.S. Cl. CPC G06Q 50/205; G09B 5/06

(57) ABSTRACT

A system and method that provides mentor assistance in an embedded marketplace is disclosed. The method includes receiving a request for assistance from a user, identifying a plurality of keywords associated with the request, identifying a plurality of tags associated with the plurality of keywords, matching a plurality of tags associated with the plurality of keywords, and routing the request to the mentor based on the match.

### CROSS-REFERENCE TO RELATED APPLICATIONS

This application claims priority to U.S. Provisional Patent Application No. 62/084,238, filed Nov. 25, 2014, titled “Methods and Systems for Providing Expert Software Development Assistance with an Embedded Marketplace,” the entirety of which is herein incorporated by reference.

### BACKGROUND

The specification generally relates to providing mentor assistance in an embedded marketplace. In particular, the specification relates to a system and method for receiving a request for assistance from a user and routing the request to a mentor based on a match.

### DESCRIPTION OF THE BACKGROUND ART

Educational multimedia content providers and integrated development environments (IDEs) often include message boards and/or forums for users to interact and pose or answer questions. Such message boards and forums may be effective tools for increasing interactions between learners or software developers. However, a response to a question posed in a forum or message board may be delayed (sometimes for years) since the forums are largely unregulated and often unorganized. Therefore, there remains a need for real time a system that effectively routes a request for assistance from a learner or software developer to a qualified mentor that can help learner or software developer answer his question.

### SUMMARY

The techniques introduced herein overcome the deficiencies and limitations of the prior art, at least in part, with a system and method for providing mentor assistance in an embedded marketplace. In one embodiment, the system includes a mentor assistance application. The mentor assistance application is configured to receive a request for assistance from a user. The mentor assistance application is further configured to identify a plurality of keywords associated with the request. The mentor assistance application is further configured to identify a plurality of tags associated with the plurality of keywords. The mentor assistance application is further configured to match the plurality of tags to a skill set associated with a mentor. The mentor assistance application is further configured to route the request to the mentor based on the match.

In another embodiment, the mentor assistance application is configured to retrieve a mentorship history for a mentor. The mentor assistance application is further configured to retrieve a mentor profile for the mentor. The mentor assistance application is further configured to calculate a mentorship score for the mentor based on the mentorship history and the mentor profile. The mentor assistance application is further configured to receive a user feedback for the mentor. The mentor assistance application is further configured to adjust the mentorship score for the mentor based on the user feedback.

In another embodiment, the mentor assistance application is configured to receive a request for assistance from a user. The mentor assistance application is further configured to identify a plurality of tags associated with the request. The mentor assistance application is further configured to retrieve a mentorship score for each mentor in the list of mentors. The mentor assistance application is further configured to calculate a match score for each mentor based on the mentorship score, a mentor profile and a user profile. The mentor assistance application is further configured to rank the list of mentor profiles based on the match score.

Other aspects include corresponding methods, systems, apparatuses, and computer program products for these and other innovative aspects.

The features and advantages described herein are not all-inclusive and many additional features and advantages will be apparent to one of ordinary skill in the art in view of the figures and description. Moreover, it should be noted that the language used in the specification has been principally selected for readability and instructional purposes and not to limit the scope of the techniques described.

### BRIEF DESCRIPTION OF THE DRAWINGS

The techniques introduced herein are illustrated by way of example, and not by way of limitation in the figures of the accompanying drawings in which like reference numerals are used to refer to similar elements.

FIG. 1 is a high-level block diagram illustrating one embodiment of a system for providing mentor assistance in an embedded marketplace.

FIG. 2 is a block diagram illustrating one embodiment of a computing device including a mentoring application.

FIG. 3 is a block diagram illustrating one embodiment of a request module.

FIG. 4 is a block diagram illustrating one embodiment of a selection module.

FIGS. 5-9 are graphical representations illustrating various embodiments of a user interface for receiving a request for assistance from a user.

FIG. 10 is a graphical representation illustrating one embodiment of a user interface displaying a mentoring session for a user.

FIG. 11 is an example flow diagram illustrating one embodiment of a method for routing a request to a mentor.

FIG. 12 is an example flow diagram illustrating one embodiment of a method for routing a request to a mentor.

FIGS. 13A and 13B are an example flow diagram illustrating one embodiment of a method for selecting a mentor.

FIG. 14 is a block diagram illustrating a system of various private embedded marketplaces supported by a public embedded marketplace.

### DETAILED DESCRIPTION

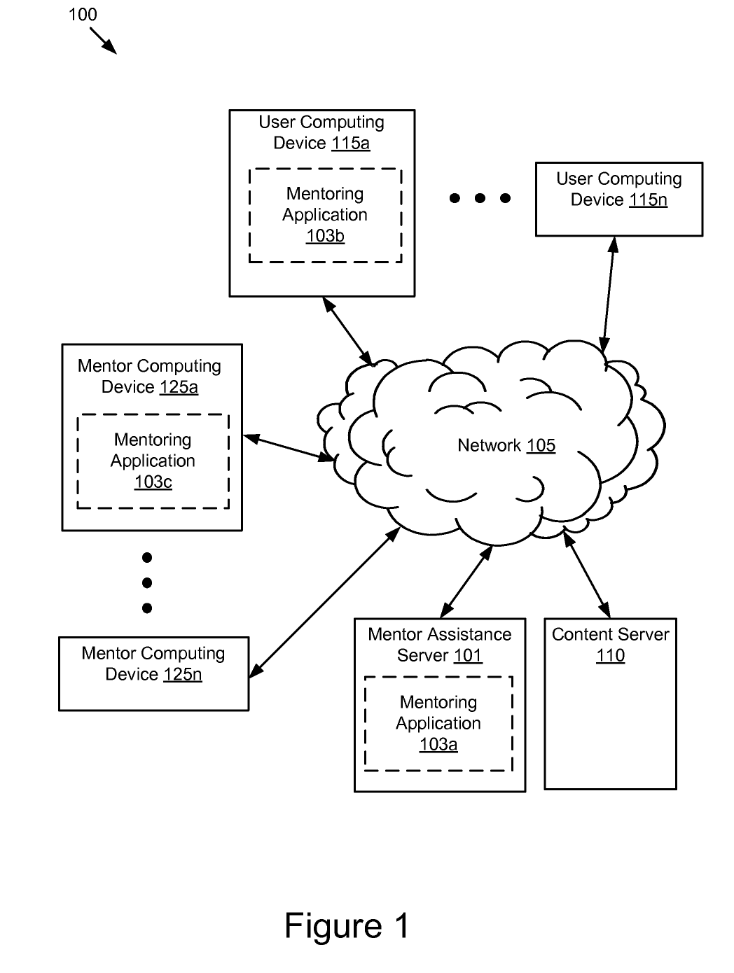

FIG. 1 is a high-level block diagram illustrating one embodiment of a system 100 for providing mentor assistance in an embedded marketplace. The illustrated system 100 may have one or more user computing devices 115a . . . 115n that can be accessed by users, one or more mentor computing devices 125a . . . 125n that can be accessed by mentors, a mentor assistance server 101, and a content server 110. In FIG. 1 and the remaining figures, a letter after a reference number, e.g., “115a,” represents a reference to the element having that particular reference number. A reference number in the text without a following letter, e.g., “115,” represents a general reference to instances of the element bearing that reference number.

In the illustrated embodiment, the entities of the system 100 are communicatively coupled via a network 105. The network 105 can be a conventional type, wired or wireless, and may have numerous different configurations including a star configuration, token ring configuration, or other configurations. Furthermore, the network 105 may include a local area network (LAN), a wide area network (WAN) (e.g., the Internet), and/or other interconnected data paths across which multiple devices may communicate. In some embodiments, the network 105 may be a peer-to-peer network. The network 105 may also be coupled to or include portions of a telecommunications network for sending data in a variety of different communication protocols. In some embodiments, the network 105 may include Bluetooth communication networks or a cellular communications network for sending and receiving data including via short messaging service (SMS), multimedia messaging service (MMS), hypertext transfer protocol (HTTP), direct data connection, WAP, email, etc. Although FIG. 1 illustrates one network 105 coupled to the user computing devices 115, the mentor computing device 125, the mentor assistance server 101, and the content server 110, in practice one or more networks 105 can be connected to these entities.

In some embodiments, the system 100 includes a mentor assistance server 101 coupled to the network 105. In some embodiments, the mentor assistance server 101 may be either a hardware server, a software server, or a combination of software and hardware. The mentor assistance server 101 may be, or may be implemented by, a computing device including a processor, a memory, applications, a database, and network communication capabilities. In the example of FIG. 1, the components of the mentor assistance server 101 are configured to implement a mentoring application 103 described in more detail below. In one embodiment, the mentor assistance server 101 receives a user request for assistance, identifies tags associated with the request, and matches the request for assistance with a mentor using the tags and a skill set associated with the mentor. While the examples herein describe the request for assistance in relation to an educational multimedia content, such as educational multimedia content associated with a technical subject, it should be understood that the request for assistance may be related to an integrated development environment (IDE), other websites, etc.

In some embodiments, the mentor assistance server 101 sends and receives data to and from other entities of the system 100 via the network 105. For example, the mentor assistance server 101 sends and receives data, such as user profiles, requests for assistance, mentor profiles, and mentorship history, to and from the user computing device 115 and mentor computing device 125. Although only a single mentor assistance server 101 is shown in FIG. 1, it should be understood that there may be any number of mentor assistance servers 101 or a server cluster.

In some embodiments, the system 100 includes a content server 110 coupled to the network 105. In some embodiments, the content server 110 may be either a hardware server, a software server, or a combination of software and hardware. The content server 110 may be, or may be implemented by, a computing device including a processor, a memory, applications, a database, and network communication capabilities. The content server 110 may be configured to provide multimedia content (e.g., instructional videos, forums, an IDE, or the like) to a user computing device 115 and/or a mentor computing device 125. The content server 110 may further be configured to track user interaction with the multimedia content. For example, the content server 110 may track the number of plays an instructional video receives, the number of times and location of where the instructional video was paused, the number of times the instructional video was watched to completion, etc. Further, the content server 110 may identify and maintain tags associated with the multimedia content. Although only a single content server 110 is shown in FIG. 1, it should be understood that there may be any number of content servers 110 or a server cluster.

The user computing device 115 may be a computing device that includes a memory, a processor, a camera, etc. For example, the user computing device may be a laptop computer, a desktop computer, a tablet computer, a mobile telephone, a smartphone, a personal digital assistant (PDA), a mobile email device, a webcam, a user wearable computing device, or any other electronic device capable of accessing a network 105. The user computing device 115 provides general graphics and multimedia processing for applications. For example, the user computing device 115 may include a graphics processor unit (GPU) for handling graphics and multimedia processing. The user computing device 115 includes a display for viewing information provided by the mentor assistance server 101 and/or the content server 110. While FIG. 1 illustrates two user computing devices 115a and 115n, the disclosure applies to a system architecture having one or more user computing devices 115.

The user computing device 115 is adapted to send and receive data to and from the mentor assistance server 101 and the content server 110. For example, the user computing device 115 may request multimedia content from the content server 110 and display the returned multimedia content to a user. While the user computing device 115 is displaying the multimedia content, the user may indicate a need for help. For example, the user may pause an instructional video, interact with a help component of a user interface, remain idle for a period of time, etc. In some embodiments, the user computing device 115, in response to the indication from the user that he needs help, may send a request for assistance to the mentor assistance server 101.

The mentor computing device 125 may be a computing device that includes a memory, a processor, a camera, etc. For example, the mentor computing device 125 may be a laptop computer, a desktop computer, a tablet computer, a mobile telephone, a smartphone, a personal digital assistant (PDA), a mobile email device, a webcam, a user wearable computing device, or any other electronic device capable of accessing a network 105. The mentor computing device 125 provides general graphics and multimedia processing for applications (e.g., mentoring application 103). For example, the mentor computing device 125 may include a graphics processor unit (GPU) for handling graphics and multimedia processing. The mentor computing device 125 includes a display for viewing information provided by the mentor assistance server 101. While FIG. 1 illustrates two mentor computing devices 125a and 125n, the disclosure applies to a system architecture having one or more mentor computing device 125.

The mentor computing device 125 is adapted to send and receive data to and from the mentor assistance server 101 and the content server 110 via the network 105. For example, the mentor computing device 125 may receive a mentorship request from the mentor assistance server 101. A mentor may accept the request via a mentor interface provided by the mentoring application 103 and establish a mentoring session as described in more detail below. The mentor computing device may transmit and receive data (e.g., video, audio, text, etc.) from the mentor assistance server 101 to implement an interface for a live mentoring session with the user.

The mentoring application 103 may include software and/or logic to provide the functionality for receiving a request for assistance from a user, identifying a mentor to take the request, routing the request to the mentor, establishing a live mentoring session between the user and the mentor, among other things described herein. In some embodiments, the mentoring application 103b and 103c may be thin-client applications with some functionality executed on the user computing device 115 and mentor computer device 125 and additional functionality executed on the mentor assistance server 101 by mentoring application 103a.

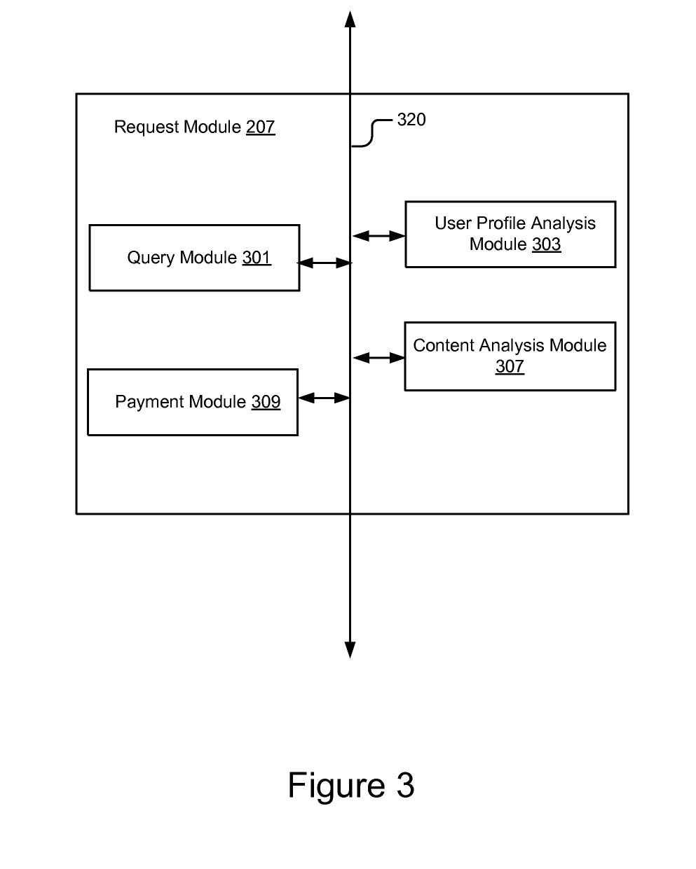

In some embodiments, the mentoring application 103 receives assessment results for one or more mentors. The mentoring application 103 determines a level of expertise for the mentors based on the assessment results. The mentoring application 103 calculates a mentorship score for the mentors based on a mentor profile and a mentorship history. The mentoring application 103 determines a match score for a mentor. The mentoring application 103 ranks a list of mentors based on a match score. The operation of the mentoring application 103 and the functions listed above are described in more detail below with reference to FIGS. 3-13.

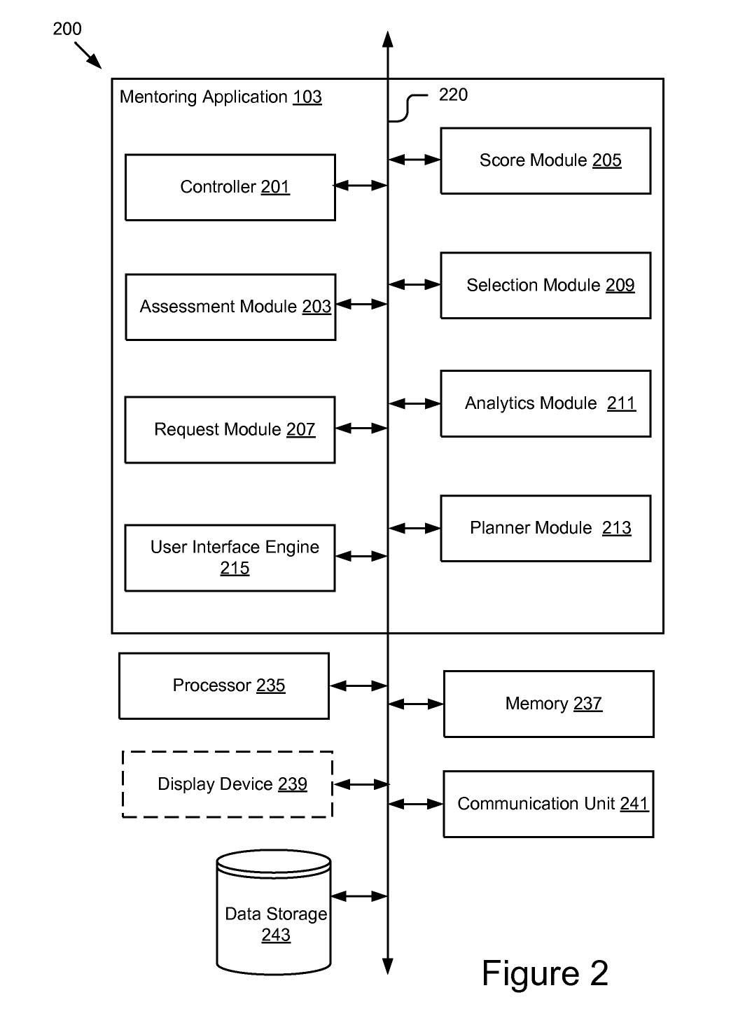

FIG. 2 is a block diagram illustrating one embodiment of a computing device 200 including a mentoring application 103. The computing device 200 may also include a processor 235, a memory 237, an optional display device 239, a communication unit 241, and data storage 243, according to some embodiments. The components of the computing device 200 are communicatively coupled by a bus or software communication mechanism 220. The bus 220 may represent one or more buses including an industry standard architecture (ISA) bus, a peripheral component interconnect (PCI) bus, a universal serial bus (USB), or some other bus known in the art to provide similar functionality. In some embodiments, the computing device 200 may be the user computing device 115, the mentor computing device 125, the mentor assistance server 101, the content server 110, or a combination of these. In such embodiments where the computing device 200 is the user computing device 115, the mentor computing device 125, the mentor assistance server 101 or the content server 110, it should be understood that the user computing device 115, the mentor computing device 125, the mentor assistance server 101, and the content server 110 may include other components not shown in FIG. 2.

The processor 235 may execute software instructions by performing various input/output, logical, and/or mathematical operations. The processor 235 may have various computing architectures to process data signals including, for example, a complex instruction set computer (CISC) architecture, a reduced instruction set computer (RISC) architecture, and/or an architecture implementing a combination of instruction sets. The processor 235 may be physical and/or virtual, and may include a single processing unit or a plurality of processing units and/or cores. ln some implementations, the processor 235 may be capable of generating and providing electronic display signals to a display device, supporting the display of images, capturing and transmitting images, performing complex tasks, etc. In some implementations, the processor 235 may be coupled to the memory 237 via the bus 220 to access data and instructions therefrom and store data therein. The bus 220 may couple the processor 235 to the other components of the computing device 200 including, for example, the memory 237, the display device 239, the communication unit 241, the mentor assistance application 103, and the data storage 243. It will be apparent that other processors, operating systems, sensors, displays and physical configurations are possible.

The memory 237 may store and provide access to data for the other components of the computing device 200. The memory 237 may be included in a single computing device or distributed among a plurality of computing devices. In some implementations, the memory 237 may store instructions and/or data that may be executed by the processor 235 The instructions and/or data may include code for performing the techniques described herein. For example, in one embodiment, the memory 237 may store the mentoring application 103. The memory 237 is also capable of storing other instructions and data, including, for example, an operating system, hardware drivers, other software applications, databases, etc. The memory 237 may be coupled to the bus 220 for communication with the processor 235 and the other components of the computing device 200.

The memory 237 may include one or more non-transitory computer-usable (e.g., readable, writeable) devices, a dynamic random access memory (DRAM) device, a static random access memory (SRAM) device, an embedded memory device, a discrete memory device (e.g., a PROM. FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 235. In some implementations, the memory 237 may include one or more of volatile memory and non-volatile memory. It should be understood that the memory 237 may be a single device or may include multiple types of devices and configurations.

The display device 239 may be a liquid crystal display (LCD), light emitting diode (LED) or any other similarly equipped display device, screen or monitor. The display device 239 represents any device equipped to display user interfaces, electronic images, and data as described herein. In different embodiments, the display is binary (only two different values for pixels), monochrome (multiple shades of one color), or allows multiple colors and shades. The display device 239 is coupled to the bus 220 for communication with the processor 235 and the other components of the computing device 200. It should be noted that the display device 239 is shown in FIG. 2 with dashed lines to indicate it is optional. For example, where the computing device 200 is the user computing device 115 or the mentor computing device 125, the display device 239 may be included and used to display user interfaces for mentoring sessions.

The communication unit 241 is hardware and/or software for receiving and transmitting data by linking the processor 235 to the network 105 and other processing systems. In one embodiment, the communication unit 241 may include a port for direct physical connection to the user computing device 115 or to another communication channel. For example, the communication unit 241 may include an RJ45 port or similar port for wired communication with the user computing device 115. In another embodiment, the communication unit 241 may include a wireless transceiver (not shown) for exchanging data with the user computing device 115 or any other communication channel using one or more wireless communication methods, such as IEEE 802.11, IEEE 802.16, Bluetooth® or another suitable wireless communication method.

In yet another embodiment, the communication unit 241 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another embodiment, the communication unit 241 may include a wired port and a wireless transceiver. The communication unit 241 also provides other conventional connections to the network 105 for distribution of files and/or media objects using standard network protocols such as TCP/IP, HTTP, HTTPS and SMTP as will be understood to those skilled in the art.

The data storage 243 is a non-transitory memory that stores data for providing the functionality described herein. The data storage 243 may be a dynamic random access memory (DRAM) device, a static random access memory (SRAM) device, flash memory or some other memory devices. In some embodiments, the data storage 243 also may include a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In the illustrated embodiment, the data storage 243 is communicatively coupled to the bus 220. The data storage 243 may store data for analyzing a received user query and mentor profile results and other functionality as described herein. For example, the data storage 243 may store a plurality of tags associated with a skill set of a mentor. The data storage may store a plurality of tags associated with content. Additionally, the data storage 243 may store datasets used in evaluating the mentorship score for the mentors. In some embodiments, the data storage 243 stores assessment results for a mentor.

In some embodiments, the mentoring application 103 may include a controller 201, an assessment module 203, a score module 205, a request module 207, a selection module 209, an analytics module 211, a planner module 213, and a user interface engine 215. The components of mentoring application 103 are communicatively coupled via the software communication mechanism 220. The components of the mentoring application 103 can be implemented using programmable or specialized hardware including a field-programmable gate array (FPGA) or an application-specific integrated circuit (ASIC). In some embodiments, the components of the mentoring application 103 can be implemented using a combination of hardware and software executable by processor 235. In some embodiments, the components of the mentoring application 103 are a set of instructions executable by the processor 235. In some implementations, the components of the mentoring application 103 are stored in the memory 237 and are accessible and executable by the processor 235. In some implementations, the components of the mentoring application 103 are adapted for cooperation and communication with the processor 235, the memory 237, and other components of the mentoring application 103 via the bus or software communication mechanism 220.

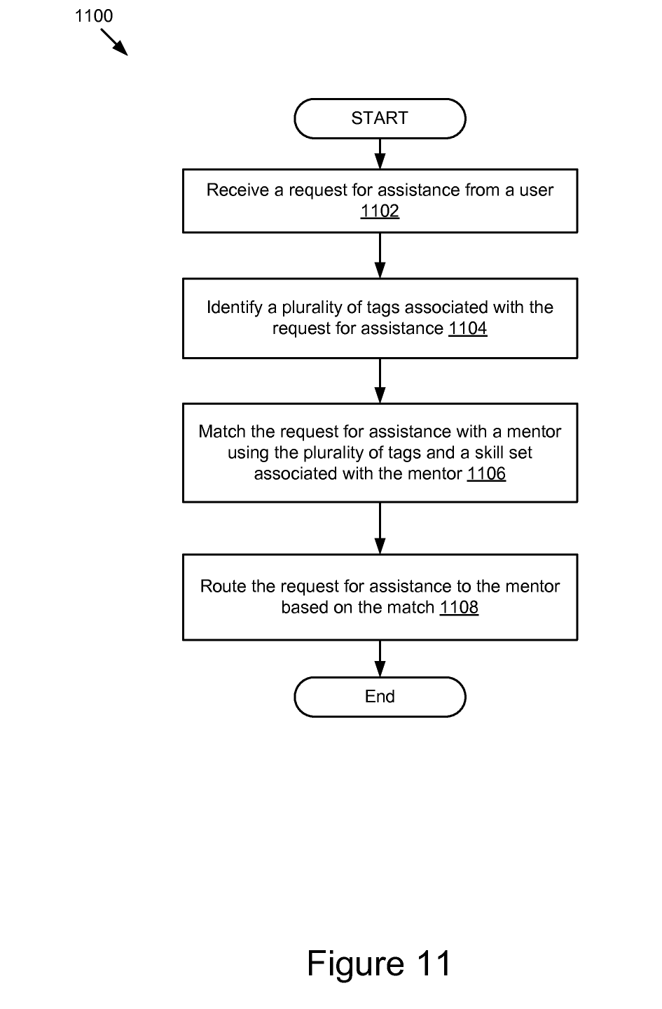

The controller 201 may include software and/or logic to control the operation of the other components of the mentoring application 103. The controller 201 controls the other components of the mentoring application 103 to perform the methods described below with reference to FIGS. 11-13. The controller 201 may also include software and/or logic to provide the functionality for handling communications between the mentoring application 103 and other components of the computing device 200 as well as between the components of the mentoring application 103.

In some embodiments, the controller 201 sends and receives data, via the communication unit 241, to and from one or more of the user computing device 115, the mentor computing device 125, the mentor assistance server 101 and the content server 110. For example, the controller 201 receives, via the communication unit 241, a request for assistance from a user computing device 115 operated by a user and sends the request to the request module 207. In another example, the controller 201 receives data describing mentor profiles and mentorship history and sends the data to the score module 205.

In some embodiments, the communications between the mentoring application 103 and other components of the computing device 200 as well as between the components of the mentoring application 103 can occur independent of the controller 201.

The assessment module 203 may include software and/or logic for providing quizzes to assess technical abilities of a mentor. For example, to determine the level of expertise for a mentor, in one embodiment, the assessment module 203 generates and administers qualification quizzes to the mentor.

In some embodiments, the assessment module 203 identifies a skill level of a user in a technical area to determine if the user has the technical ability to become a mentor. For example, the assessment module 203 In some embodiments, the assessment module 203 generates a customized quiz for assessing the technical ability of a mentor. For example, the assessment module 203 may determine whether a mentor has gained enough experience to advance to the next level of expertise.

In some embodiments, the assessment module 203 assesses the technical abilities for a user. For example, the assessment module 203 retrieves the user profile and generates an assessment quiz to refine the user profile. Using the results for the assessment quiz, the mentoring application 103 may quickly determine an experience level of a mentor for the user. This enables the mentoring application 103 route a help request from the user in a more efficient manner. In some embodiments, the assessment module 203 creates the assessment quiz based on an education background of the user.

The score module 205 may include software and/or logic for calculating a mentorship score for a mentor. The mentorship score may be made up of various components measuring skills of a mentor to provide an overall sketch of the mentor's quality. For example, the mentorship score may include an education component, an assessment component, a feedback component, and the like. In some embodiments, a mentor may have an overall score and different mentorship scores for different technical areas. In some embodiments, the score module 205 identifies a proficiency level for a mentor based on the mentorship score. For example, the score module 205 has a threshold score for classifying a mentor as an expert mentor, a proficient mentor, or a beginner mentor.

In some embodiments, the score module 205 retrieves a mentor profile from the data storage 243 and determines the mentorship score for the mentor based on his profile. The mentor profile may include an educational background of the mentor, a level of expertise for the mentor, results from the most recent assessment quiz, technical subjects associated with the mentor, tags associated with the mentor, and a mentorship history for the mentor. The mentorship history describes a history of mentoring sessions provided by the mentor and information related to content associated with the mentoring session. In some embodiments, the mentorship history includes a number of mentoring sessions declined by the mentor and a number of mentoring sessions accepted by the mentor. In some embodiments, the score module receives data from third party systems or services (e.g., IDE contributions, publications, etc.) to include in the mentorship score.

In some embodiments, the score module 205 receives user feedback for a mentor. For example, the score module 205 may receive user feedback from a user for a specific mentor assistance session. The score module 205 may increase the mentorship score based on positive user feedback and decrease the mentorship score based on negative user feedback. In some embodiments, the user feedback may include user ratings for a mentor. For example, the score module 205 may receive ratings from 1 star to 5 stars and adjust a feedback component of the mentorship score based on the ratings. For example, a 5 star rating may represent 10 points, a 4 star rating may represent 5 points, a 3 star rating may represent no point, a 2 star rating may represent—15 points and a 1 star rating may represent—30 points. As described, a high score in the feedback component of a mentorship score implies that the mentor had more positive user feedback and a lower variance implies that the mentor has a consistent performance level. This enables the mentoring application 103 to prioritize a request for assistance from a user.

In some embodiments, the score module 205 allocates an average score for a new mentor at the beginning The mentorship score may then be adjusted as the mentor progresses (e.g., based on user feedback, additional education, assessments, etc.). This method advantageously provides equal chance for beginner mentors to receive mentoring opportunities and increase (or decrease) their reputation.

The request module 207 may include software and/or logic for receiving and processing a request for assistance from a mentor. In some embodiments, the request for assistance is associated with multimedia content from the content server 110. For example, the user may watch an instructional video and the user may request assistance with understanding the content in the video. Similarly, the user may be coding in an IDE and need assistance with a piece of code (e.g., detecting or fixing a bug, an architecture question, code review, or the like). In some embodiments, the request module 207 may request additional information to improve matching with a mentor. For example, the request module 207 may provide an input field to receive text input describing the user's problem or question. The information may be used to route the request for assistance to an appropriate mentor. The request module 207 is described in more detail with reference to FIG. 3.

FIG. 3 is a block diagram illustrating one embodiment of a request module 207. The request module 207 may include a query module 301, a user profile analysis module 303, a content analysis module 307, and a payment module 309, according to some embodiments. The components of the request module are communicatively coupled by a bus or software communication mechanism 320.

The query module 301 may include software and/or logic for processing additional information provided by a user along with a request for assistance. The query module 301 may use natural language processing (NLP) techniques to parse the user input to determine keywords and/or context of the statements or questions provided by the user. In some embodiments, the query module 301 uses machine learning techniques to refine the NLP results. In some embodiments, the query module 301 may request the user to input more description in the input field. In an alternative embodiment, the query module 301 may also present some related tags to the user. The user may select one or more tags for refining the request.

In some embodiments, the query module 301 identifies tags based on the user input. A tag can be an index term assigned to multimedia content provided by the content server 110. Accordingly, the tag identifies the technology addressed in the multimedia content associated with the request for assistance.

In some embodiments, the query module 301 receives an urgency notification from the user. For example, a user may specify if the user wants instantaneous support or they can wait and receive support after certain time period. The users can also specify a level of difficulty of the problem. This helps the mentoring application 103 route the request most efficiently to a mentor who is able to handle the problem. In some embodiments, the query module 301 presents an option to the user to leave an instant message for the mentors. For example, if no mentor is immediately available, the user can leave an instant message describing the problem for the next available mentor. In some embodiments, the user can book time slots with a particular mentor. The user can also specify the preferred type of session. For example, the user can specify if they prefer a mentor assistance session through video call session, a mentor assistance session through live coding help, or a mentor assistance session via voice (e.g., phone call, VoIP, or the like) and screen share. In some embodiments, the user may specify a length of the mentor assistance session. The user can also specify if they want a timer embedded in the mentor assistance session.

The user profile analysis module 303 may include software and/or logic for analyzing a user profile associated with a request. In some embodiments, the user profile analysis module 303 may retrieve information associated with the user making the request. For example, the user profile may include demographic information of the user, a technical background of the user, and languages spoken by the user. In some embodiments, the user profile may also include a history of previous content consumed by the user from the content server 110. For example, the content may include educational videos. The user profile analysis module 303 may generate a personality test for the users, which specifies a personality type for the user.

The content analysis module 307 may include software and/or logic for analyzing content. In some embodiments, the content analysis module 307 receives a user request for assistance from the query module 301 and retrieves information related to content associated with the request. In some embodiments, the content analysis module 307 receives content associated with a request for assistance from the content server 110. The content analysis module 307 may analyze the content to determine one or more tags associated with the content. In some embodiments, the content analysis module 307 receives details regarding a user profile from the user profile analysis module 303 and determines tags associated with the request based on the user profile and content associated with the request.

The payment module 309 may include software and/or logic for receiving payment information from a user for a mentoring session. In some embodiments, the payment module 309 receives billing information from the user. The user can specify a maximum amount for a mentoring session. The user can specify a method of payment for the mentoring session. For example, the users can specify if they prefer to pay per mentoring session, if they prefer to receive a bill at the end of each month for all mentoring sessions in that month, or whether they prefer to prepay for blocks of time that can be used for mentoring sessions.

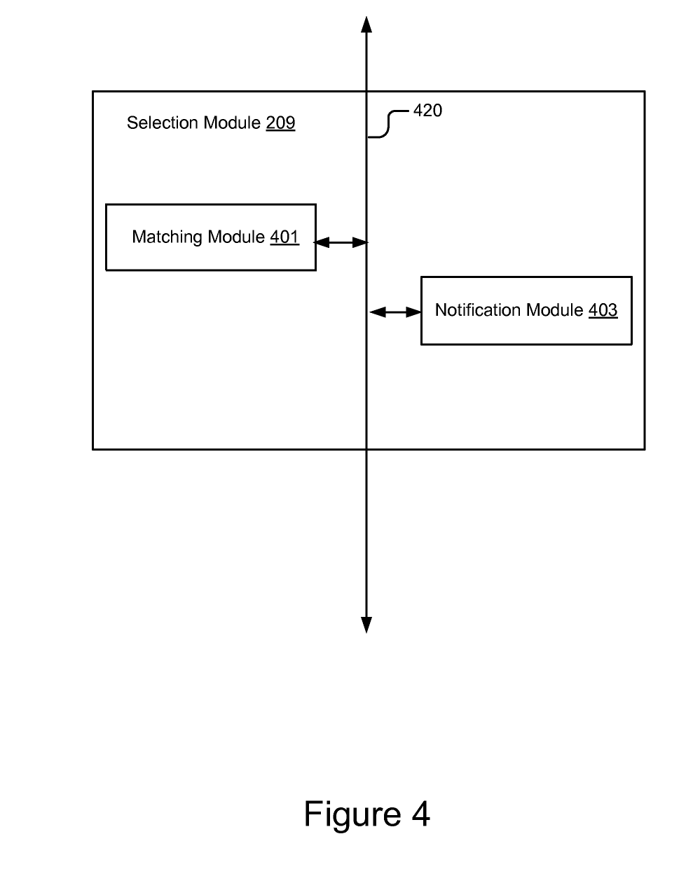

Referring back to FIG. 2, the selection module 209 may include software and/or logic for selecting a mentor based on a request for assistance from a user. The request for assistance may be a request for a mentoring session. In some embodiments, the mentor is selected from a public marketplace. For example, the request for assistance may be routed to any mentor within the public marketplace. In some embodiments, the mentor is selected from a private marketplace. For example, the request for assistance may be routed to any mentor within the private marketplace. The selection module 209 is described in more details with reference to FIG. 4.

FIG. 4 is a block diagram illustrating one embodiment of a selection module 209. The selection module 209 may include a matching module 401 and a notification module 403, according to some embodiments. The components of the selection module 209 are communicatively coupled by a bus or software communication mechanism 420.

The matching module 401 may include software and/or logic for matching a mentor with a request for assistance. In some embodiments, the matching module 401 retrieves a mentor profile. For example, the mentor profile may include a mentorship history, a mentorship score, an overall score, a technical background of the mentor, and tags associated with the mentor. The matching module 401 may receive one or more tags associated with the request from the request module 207. In some embodiments, the matching module 401 analyzes the tags associated with the mentor profile and the request to determine the best match. For example, the matching module 401 receives an indication from the request module 207 that the user making the request for assistance speaks Spanish. The matching module 401 may analyze a mentor profile to determine that the mentor speaks Spanish and routes the request based on the match.

In some embodiments, the matching module 401 retrieves a calendar for a mentor. The matching module 401 can determine availability of a mentor for a mentor assistance session, based on the calendar. In some embodiments, the matching module 401 may determine which mentors are online and match the user query to a mentor within the list of online mentors. In some embodiments, the matching module 401 may generate a match score for mentors having a skill set matching to the request. The matching module 401 may then rank the matching mentors based on the match score.

In some embodiments, the matching module 401 retrieves results for a personality test of a mentor and matches the user query based on the personality test results. For example, the user profile may suggest that the user is an introvert and the personality test result of a mentor may suggest that the mentor works well with this personality type. Then the matching module 401 may route the request to the mentor who works well with introverts.

In some embodiments, the matching module 401 receives payment information associated with the request for assistance, from the request module 207. The matching module 401 determines that the request will be routed to expert mentors if the user is paying a higher rate or the request will be routed to all other mentors if the user is paying the standard rate for mentoring sessions.

The notification module 403 may include software and/or logic for sending a notification of a request to a mentor. For example, the notification module 403 may send a notification to all online mentors having a match score that satisfies a threshold. In some embodiments, the notification module 403 may notify the mentor with the highest match score. In other embodiments, the notification module 403 may notify a set of mentors with a range of match scores. The notification module 403 determines if the request is accepted by a mentor within a threshold time. If the request is not accepted within the threshold time, the notification module 403 may send the notification of the request for assistance to another mentor or group of mentors, and so on, until the request is accepted.

Referring back to FIG. 2, analytics module 211 may include software and/or logic for analyzing user data to determine a suggested course of action (e.g., generating recommendations for a mentor or user). In some embodiments, the analytics module 211 receives a mentor profile and a mentorship score from the score module 205, a user request history from the request module 207, a content consumption history from the content server 110, a history of the tags associated with content viewed by the users from the request module 207, and the like. In some embodiments, the analytics module 211 generates a recommendation for the mentor to include additional content for the content server 110 associated with the plurality of tags based on the content consumption history.

In some embodiments, the analytics module 211 generates a global score for a mentor, identifying a world ranking for the mentor in a technical area.

The planner module 213 may include software and/or logic for providing mentorship within a private embedded marketplace. The private embedded marketplace may be implemented within a company or organization intranet, for example. In some embodiments, the private embedded marketplace may be constructed using a software development kit (SDK) provided by operators of the mentorship server and/or authors of the mentorship application. The SDK may provide access to building blocks and/or application programming interfaces (APIs) for creating a customized mentoring experience. The building blocks may include, for example, sections of code (e.g., JavaScript, Flash, Silverlight, etc.) that may be used by a company or organization to customize a webpage to include mentorship functions. The APIs may provide access to the various functions of the mentoring application 103 as described herein.

The planner module 213 may receive input from an administrator in an organization. The administrator may designate experts within the organization to be mentors or may receive an application to become a mentor form a member of the organization. The planner module 213 allows the administrator to evaluate mentoring ability and/or technical skills using the mentor scoring tools discussed herein.

In some embodiments, the planner module 213 may determine which requests for assistance require mentors to be within the organization and which requests are allowed to be broadcast to a community of mentors outside of the organization (e.g., using an API or building block provided by the SDK).

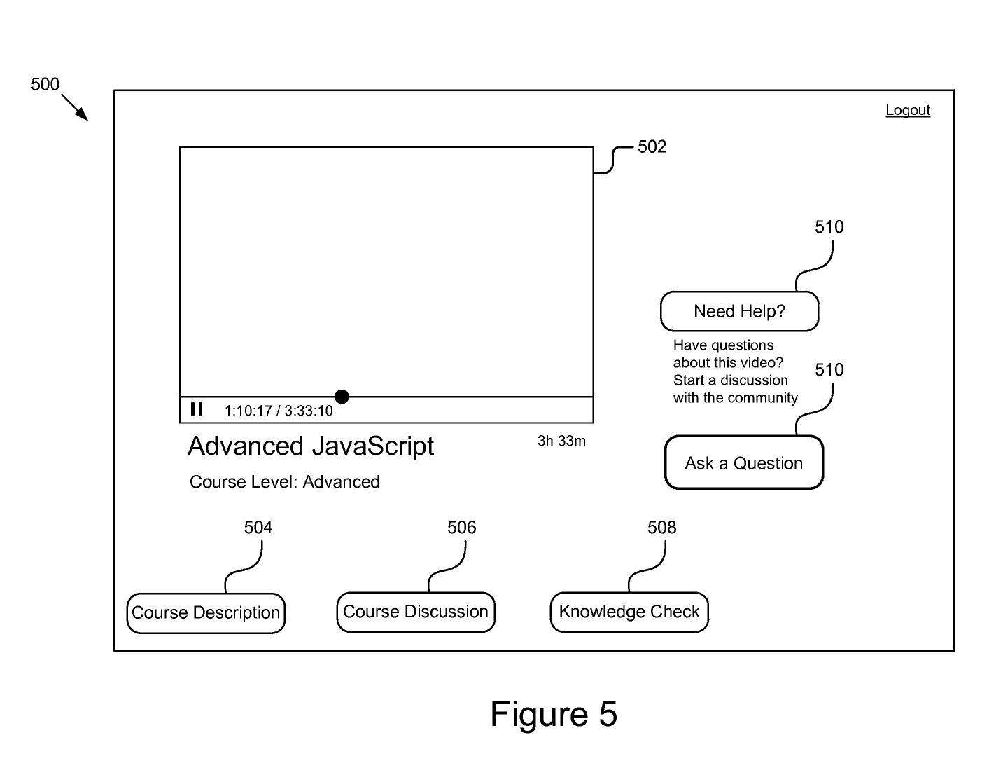

The user interface engine 215 may include software and/or logic for providing user interfaces for display on a user computing device 115 and/or a mentor computing device 125. As shown in the example of FIGS. 5-9, the graphical representations illustrate various embodiments of user interfaces for receiving a request for assistance from a user. In FIG. 5, the user interface 500 includes multimedia content 502 (e.g., an educational video provided by content server 110). As depicted in the example of FIG. 5, the user interface may also include interactive elements for accessing a course description 504, a course discussion 506, knowledge check 508, or requesting assistance 510.

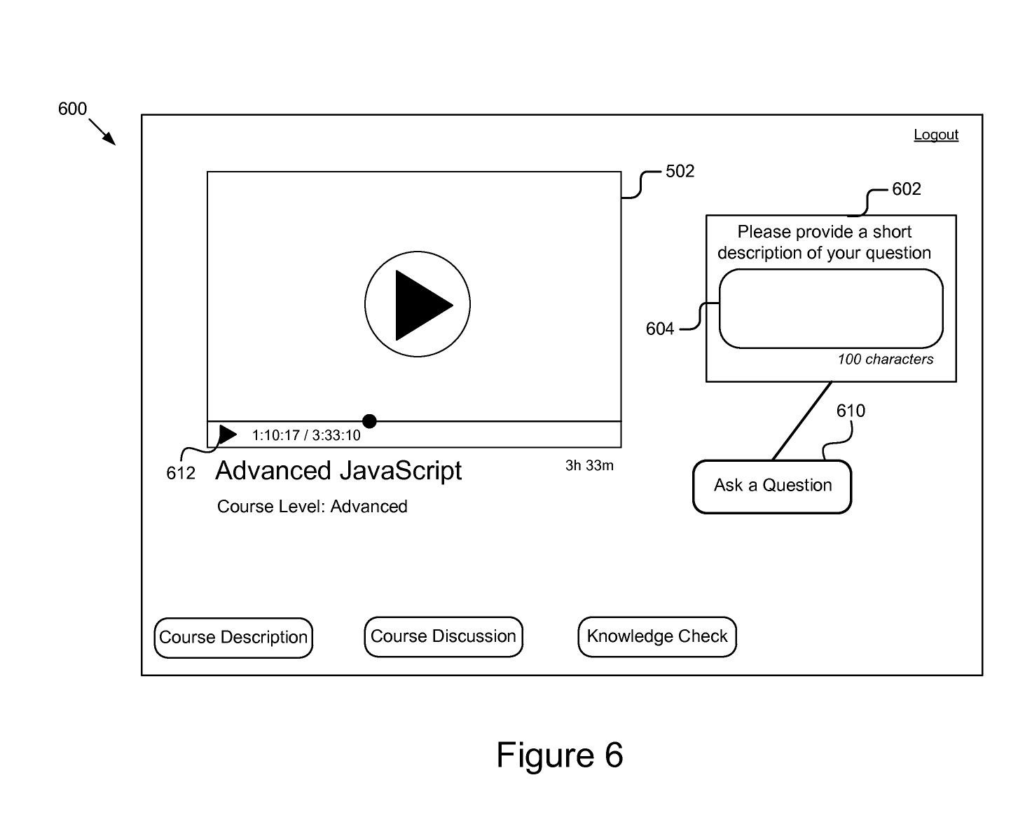

As shown in the example of FIG. 6, in response to receiving an indication of request for assistance, the graphical user interface displays a pop-up box 602 including an input field 604 for additional information describing the user's problem or question. In one embodiment, the indication of a request for assistance may be an interaction by the user with the “Ask a Question” element 610. In another embodiment, the indication of a request for assistance may be an interaction with a play/pause element 612. For example, the user interface may generate the pop-up box 602 to prompt the user to ask a question in response to the user pausing the multimedia content 502.

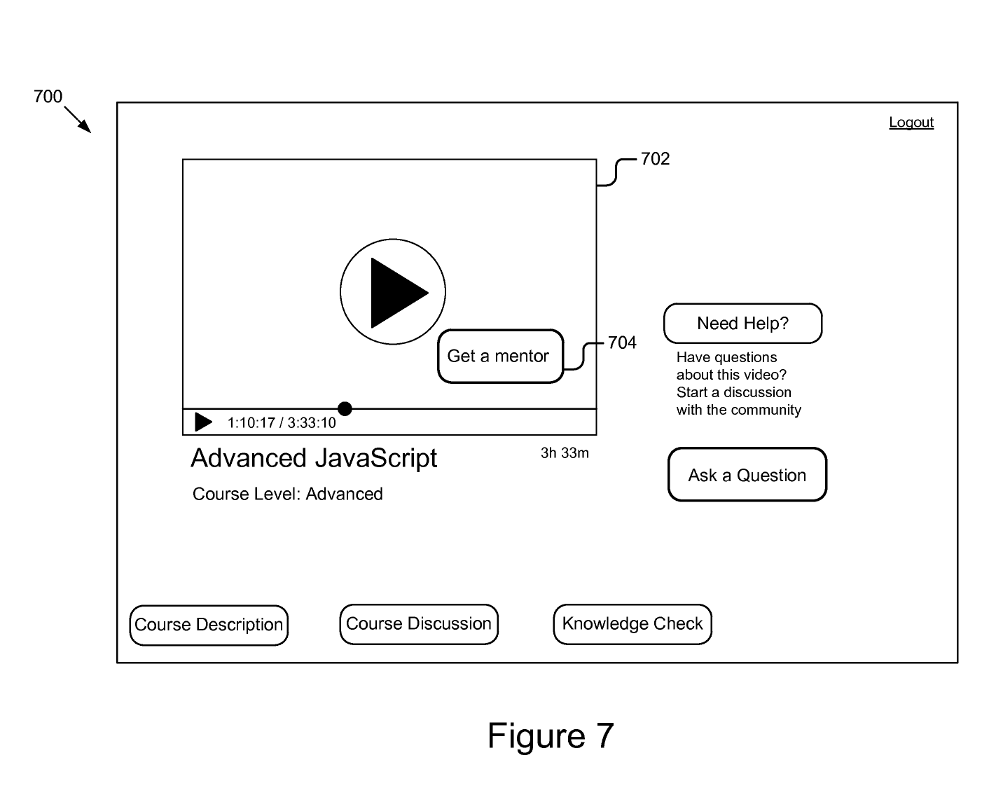

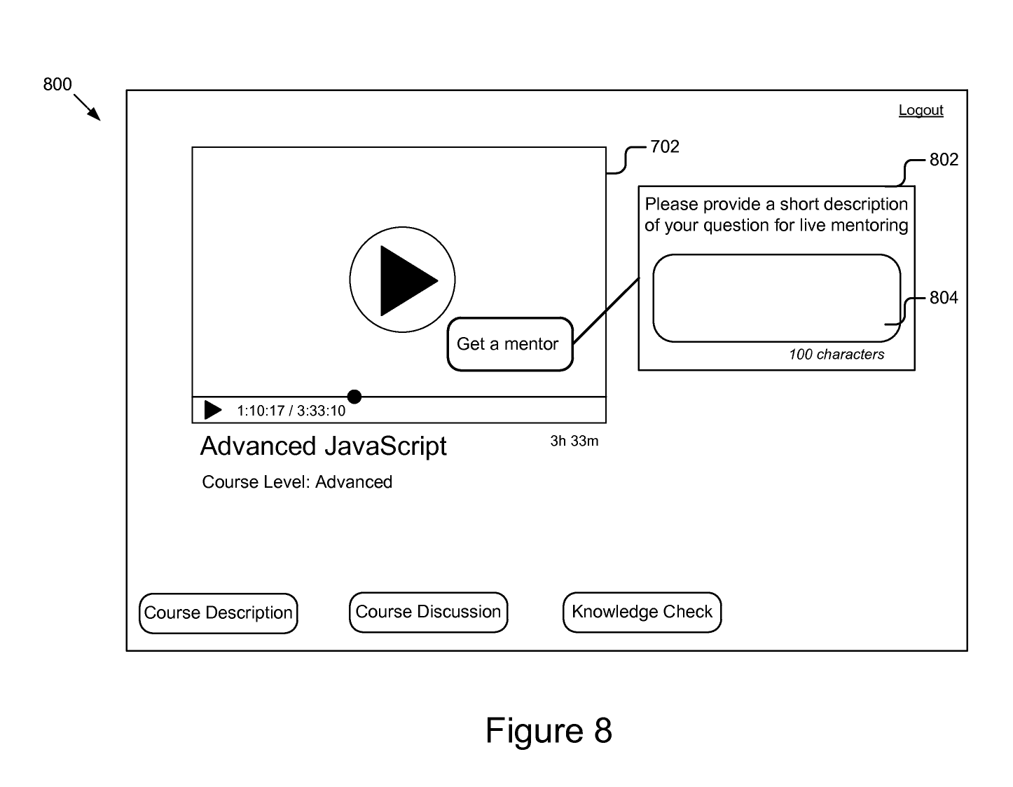

FIG. 7 illustrates another embodiment of a user interface for receiving a request for assistance from a user. In the example of FIG. 7, in response to receiving an indication that the user has paused the multimedia content 702, the graphical user interface displays a pop-up box 704 inquiring if the user would like assistance. In the example of FIG. 8, in response to receiving an indication of the request for assistance, the graphical user interface displays a pop-up box 802 including an input field 804 for additional information describing the request.

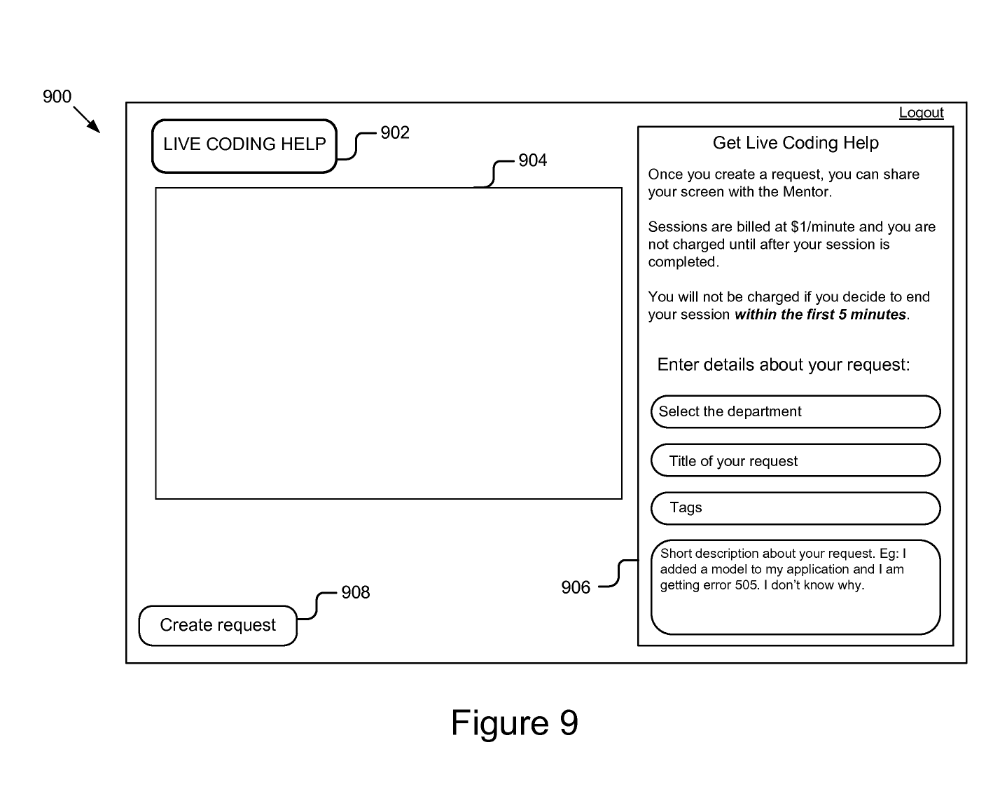

In some embodiments, the user can create a request for assistance with reference to live coding (e.g., in an IDE). The graphical user interface 900 showing the live coding help may be displayed as shown in the example of FIG. 9. The graphical user interface may include an option 906 to create a request for assistance with live coding. The request for assistance 906 may include options to add a department related to the request, a title of the request, tags associated with the request and a short description of the request. In some embodiments, the graphical user interface also includes an option 908 to create the request for assistance and send to the available mentors.

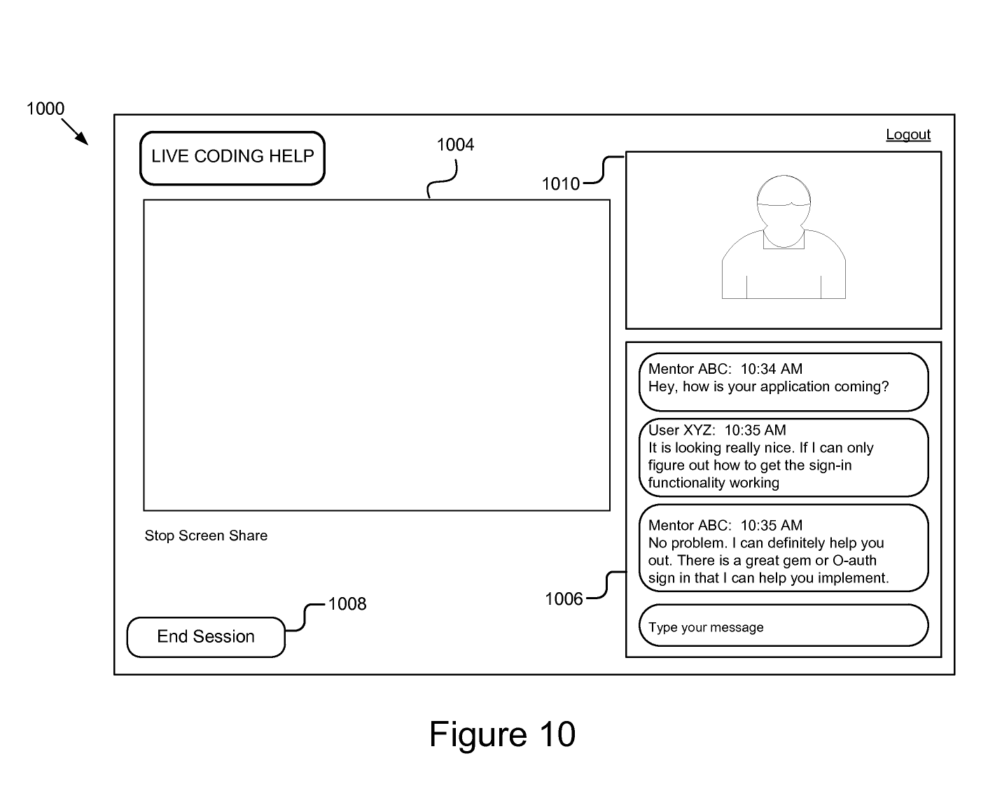

FIG. 10 illustrates another embodiment of a user interface 1000 displaying a mentoring session for a user in a live coding environment. The user interface may include a shared workspace 1004, a chat log 1006, and a video stream 1010 (e.g., a webcam chat with the mentor). In some embodiments, the graphical user interface also includes an option 1008 to end the mentoring session.

FIG. 11 is an example flow diagram illustrating one embodiment of a method 1100 for routing a request to a mentor. At 1102, the mentoring application 103 receives a request for assistance from a user. For example, the request module 207 may receive a request for assistance via a multimedia content presentation interface. At 1106, the request module 207 identifies a plurality of tags associated with the request for assistance. At 1106, the selection module 209 matches the request for assistance with a mentor using the plurality of tags and a skill set associated with the mentor. At 1108, the selection module 209 routes the request for assistance to the mentor based on the match.

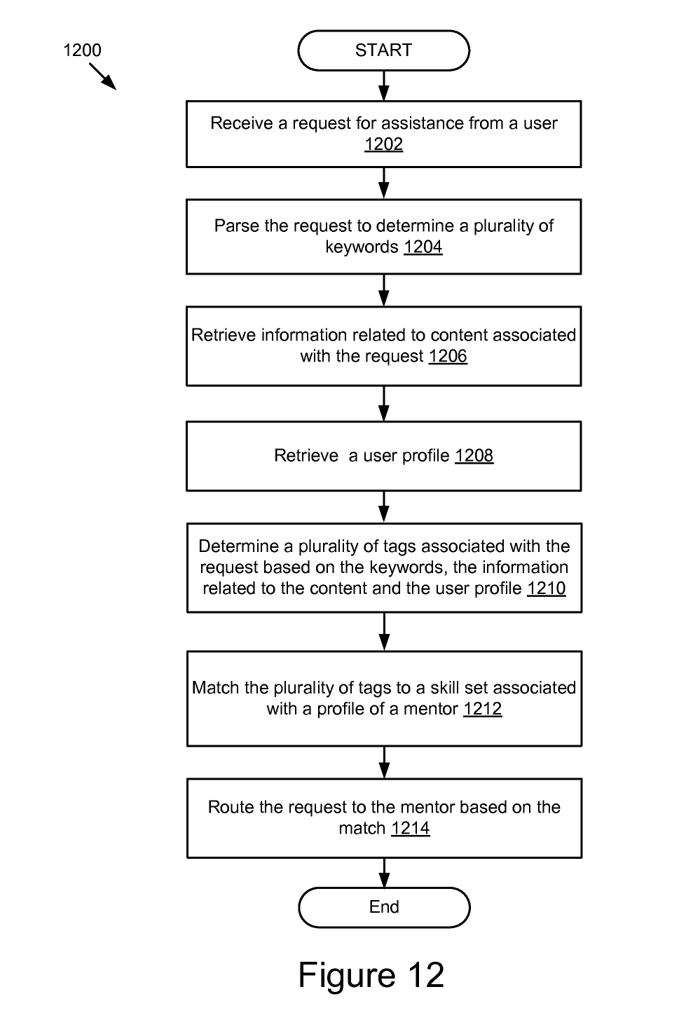

FIG. 12 is an example flow diagram illustrating one embodiment of a method 1200 for routing a request to a mentor. At 1202, the mentoring application 103 receives a request for assistance from a user. At 1204, the request module 207 parses the request to determine a plurality of keywords. At 1206, the request module 207 retrieves information related to content associated with the request. At 1208, request module 207 retrieves a user profile. At 1210, the request module 207 determines a plurality of tags associated with the request based on the keywords, the information related to the content, and the user profile. At 1212, the selection module 209 matches the plurality of tags to a skill set associated with a profile of a mentor. At 1214, the selection module 209 routes the request to the mentor based on the matches.

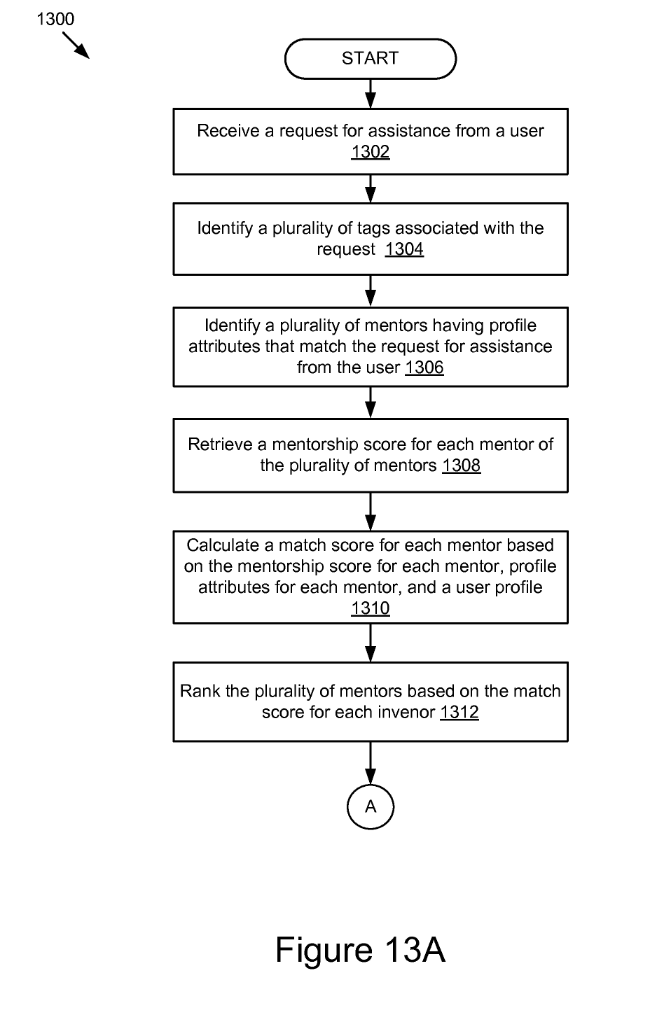

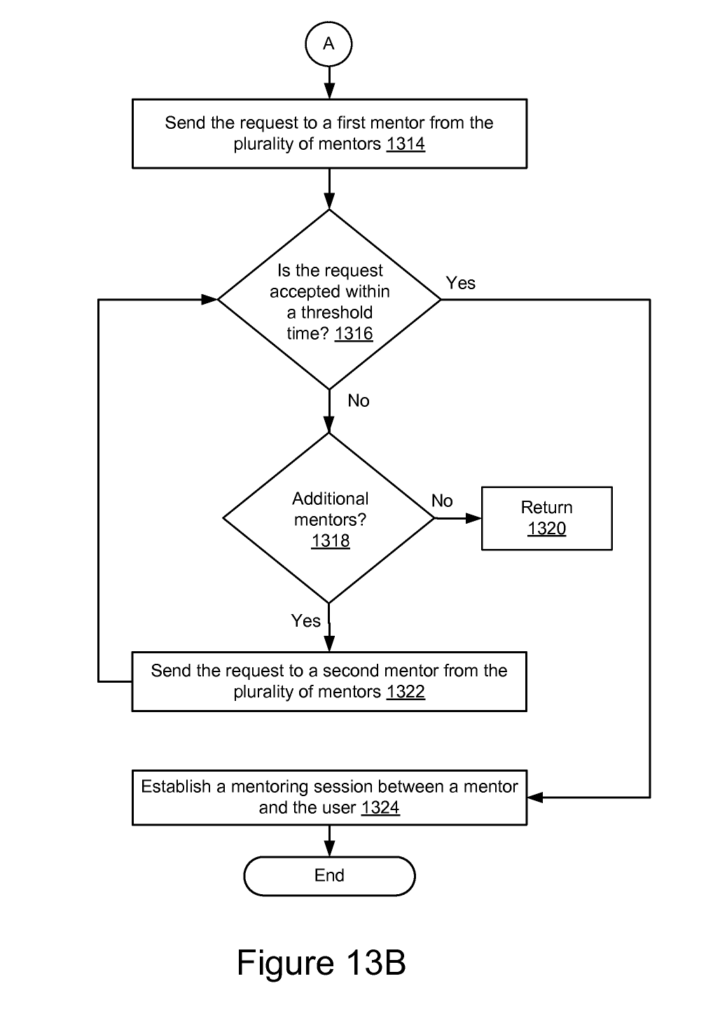

FIGS. 13A and 13B are an example flow diagram illustrating one embodiment of a method 1300 for selecting a mentor. At 1302, the request module 207 receives a request for assistance from a user. At 1304, the request module 207 identifies a plurality of tags associated with the request. At 1306, the selection module 209 identifies a plurality of mentors having profile attributes that match the request for assistance from the user. At 1308, the selection module 209 retrieves a mentorship score from a mentor profile for each mentor of the plurality of mentors. At 1310, the selection module 209 calculates a match score for each mentor based on the mentorship score for each mentor, profile attributes for each mentor, and a user profile. In some embodiments, the selection module 209 calculates the match score also using the plurality of tags associated with the request, a price associated with each of the plurality of mentors, and information related to multimedia content being presented to a user when the request for assistance was received. At 1312, the selection module 209 ranks the plurality of mentors based on the match score for each inventor.

Referring now to FIG. 13B, at 1314, in one embodiment, the selection module 209 sends the request to a first mentor of the plurality of mentors. At 1316, the selection module 209 determines whether the request is accepted within a threshold time. In response to determining that the request is not accepted within the threshold time, at 1318, the selection module 209 determines if there are additional mentors of the plurality of mentors that have not received the request. In response to determining that that there are no additional mentors, at 1320, the selection module 209 sends a notification to the user stating that there are no available mentors. In response to determining that there are additional mentors, at 1322, the selection module 209 sends the request to a second mentor of the plurality of mentors. The method then returns to determine whether the request is accepted within the threshold time at 1316. In response to determining that the request is accepted within a threshold time, at 1324, the selection module 209 establishes a mentoring session between a mentor and the user.

In various other embodiments, the selection module 209 may determine that a set of mentors have matching scores that fall within a range of scores and transmits the request to the set of mentors. The mentorship session is established between the first mentor to respond to the request and the user. Similar to the process described above, if none of the mentors in the initial set respond within a threshold time, the selection module 209 may transmit a request to other mentors (either individually or in additional sets) until the request is accepted. In some embodiments, as the request is transmitted to additional mentors or as time passes, the price received for accepting the request may be increased by the selection module 209 to encourage a mentor to accept the request.

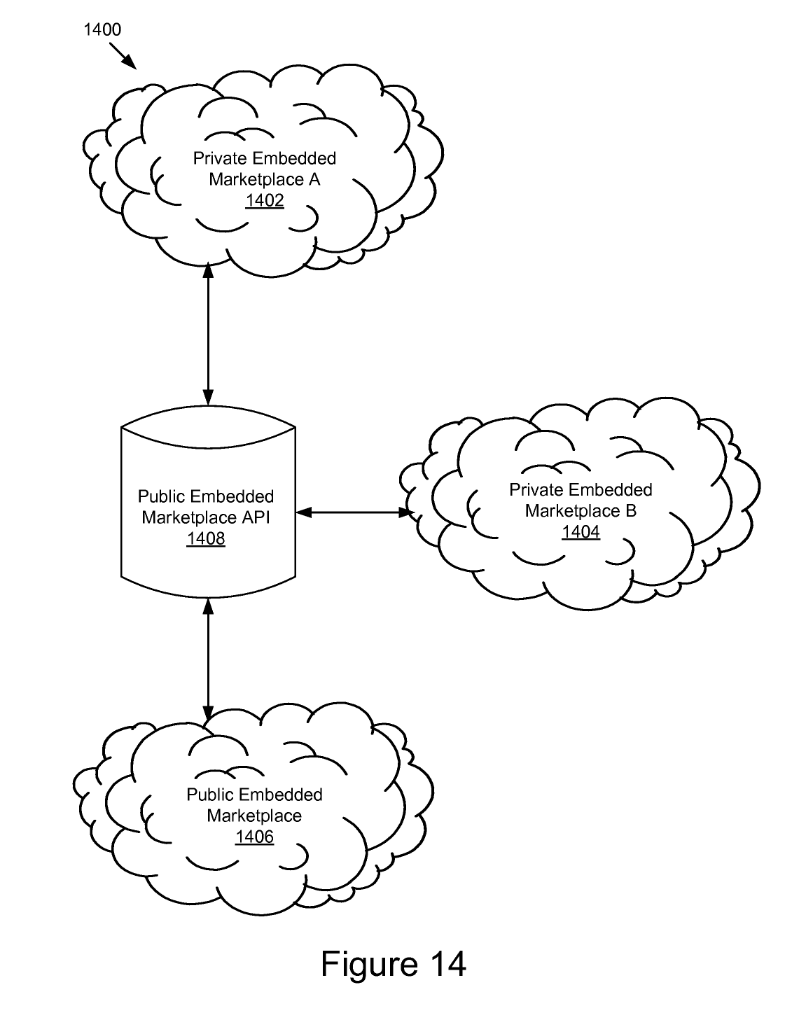

FIG. 14 is a block diagram illustrating a system of various private embedded marketplaces supported by public embedded marketplace. The endpoints of public embedded marketplace APIs 1408 can be utilized by a user and/or company to create a private embedded marketplace (e.g., private embedded marketplace A 1402 and private embedded marketplace B 1404). Private embedded marketplaces can manage their own market of mentors as described above. A private embedded marketplace can be a customer of public embedded marketplace 1406 and develop their own customized version of an embedded marketplace by using features provided in an SDK (e.g., video chat, open directory of mentors vs. closed managed service, ratings, collaboration technologies, workflows, tipping, reviews, notifications, etc.). Accordingly, a private embedded marketplace can leverage technologies of the public embedded marketplace 1406 via the public embedded marketplace's APIs 1408.

The mentors within private embedded marketplace A 1402 and private marketplace B 1404 can be allowed to become part of the network of mentors within the public embedded marketplace 1406. In some embodiments, the private embedded marketplace A 1402 and the private embedded marketplace B 1404 can use public embedded marketplace APIs 1408 to create their own help center between their internal programmers and experts. In some embodiments, the private embedded marketplace A 1402 and the private embedded marketplace B 1404 receive notifications via public embedded marketplace API 1408. Public embedded marketplace API 1408 can include endpoints used to connect any vertical of expertise (e.g., legal, accounting, medical, hardware, business consulting, etc.), where any user/company creates their own private embedded marketplace for ‘x’.

A system and method for providing mentor assistance has been described. In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding. For example, the techniques are described in one embodiment above primarily with reference to software and particular hardware. However, the present invention applies to any type of computing system that can receive data and commands, and present information as part of any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions described above are presented in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. One embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code can include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description above. In addition, the techniques are not described with reference to any particular programming language. It will be appreciated that a variety of programming languages may be used to implement the teachings of the various embodiments as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method comprising:
receiving, by one or more processors, a request for assistance from a user via a multimedia content presentation interface;
identifying, by the one or more processors, a plurality of tags associated with the request for assistance;
matching, by the one or more processors, the request for assistance with a mentor using the plurality of tags and a skill set associated with the mentor; and
routing, by the one or more processors, the request for assistance to the mentor based on the match.

2. The computer-implemented method of claim 1, further comprising:
generating, by the one or more processors, a request interface for the user in response to the request for assistance, wherein the request interface includes an input field to receive text input describing the request for assistance;
performing, by the one or more processors, natural language processing on the text input to determine the plurality of tags associated with the request for assistance.

3. The computer-implemented method of claim 1, further comprising:
retrieving, by the one or more processors, information describing the multimedia content being presented to the user when the request for assistance was received; and
identifying, by the one or more processors, the plurality of tags based on the information describing the multimedia content being presented to the user when the request for assistance was received.

4. The computer-implemented method of claim 1, further comprising:
retrieving, by the one or more processors, a mentor profile associated with the mentor; and
determining, by the one or more processors, the skill set associated with the mentor based on the mentor profile.

5. The computer-implemented method of claim 1, further comprising:
retrieving, by the one or more processors, a user profile associated with the user; and
matching the request for assistance with the mentor based on the user profile.

6. The computer-implemented method of claim 1, further comprising:
establishing, by the one or more processors, a mentoring session between the mentor and the user.

7. The computer-implemented method of claim 6, further comprising:
determining that the mentoring session has ended; and
generating a payment notification for the user based on a duration of the mentoring session.

8. A system comprising:
one or more processors; and
a memory storing instructions, which when executed cause the one or more processors to:
receive a request for assistance from a user via a multimedia content presentation interface;
identify a plurality of tags associated with the request for assistance;
match the request for assistance with a mentor using the plurality of tags and a skill set associated with the mentor; and
route the request for assistance to the mentor based on the match.

9. The system of claim 8, wherein the instructions cause the one or more processors to:
generate a request interface for the user in response to the request for assistance, wherein the request interface includes an input field to receive text input describing the request for assistance; and
perform natural language processing on the text input to determine the plurality of tags associated with the request for assistance.

10. The system of claim 8, wherein the instructions cause the one or more processors to:
retrieve information describing the multimedia content being presented to the user when the request for assistance was received; and
identify the plurality of tags based on the information describing the multimedia content being presented to the user when the request for assistance was received.

11. The system of claim 8, wherein the instructions cause the one or more processors to:
retrieve a mentor profile associated with the mentor; and
determine the skill set associated with the mentor based on the mentor profile.

12. The system of claim 8, wherein the instructions cause the one or more processors to:
retrieve a user profile associated with the user; and
match the request for assistance with the mentor based on the user profile.

13. The system of claim 8, wherein the instructions cause the one or more processors to:
establish a mentoring session between the mentor and the user.

14. The system of claim 13, wherein the instructions cause the one or more processors to:
determine that the mentoring session has ended; and
generate a payment notification for the user based on a duration of the mentoring session.

15. A non-transitory computer-readable medium storing instructions which, when executed by one or more processors, causes the one or more processors to:
receive a request for assistance from a user via a multimedia content presentation interface;
identify a plurality of tags associated with the request for assistance;
match the request for assistance with a mentor using the plurality of tags and a skill set associated with the mentor; and
route the request for assistance to the mentor based on the match.

16. The non-transitory computer-readable medium of claim 15, wherein the instructions cause the one or more processors to:
generate a request interface for the user in response to the request for assistance, wherein the request interface includes an input field to receive text input describing the request for assistance; and
perform natural language processing on the text input to determine the plurality of tags associated with the request for assistance.

17. The non-transitory computer-readable medium of claim 15, wherein the instructions cause the one or more processors to:
retrieve information describing the multimedia content being presented to the user when the request for assistance was received; and
identify the plurality of tags based on the information describing the multimedia content being presented to the user when the request for assistance was received.

18. The non-transitory computer-readable medium of claim 15, wherein the instructions cause the one or more processors to:
retrieve a mentor profile associated with the mentor; and
determine the skill set associated with the mentor based on the mentor profile.

19. The non-transitory computer-readable medium of claim 15, wherein the instructions cause the one or more processors to:
retrieve a user profile associated with the user; and
match the request for assistance with the mentor based on the user profile.

20. The non-transitory computer-readable medium of claim 15, wherein the instructions cause the one or more processors to:
establish a mentoring session between the mentor and the user.
